(19) United States
(12) Patent Application Publication
(10) Pub. No.: US 2004/0065773 A1
(43) Pub. Date: Apr. 8, 2004

(54) Method and apparatus to make a cyclone

(76) Inventor: Fernando Morales, Reston, VA (US)

Correspondence Address: ROBERTS ABOKHAIR & MARDULA, SUITE 1000, 11800 SUNRISE VALLEY DRIVE, RESTON, VA, 20191, US

(21) Appl. No.: 10/262,793

(22) Filed: Oct. 2, 2002

(51) Int. Cl. B64B 1/02; B64B 1/06

(52) U.S. Cl. 244/30

(57) ABSTRACT

A method and system to make a cyclone. Delivery of almost vertical sun energy to a water target area is accomplished using floating mirrors. One or more Floating Mirrors are suspended from balloons or alternatively place in orbit around the earth, and are parked and maintained at a given position above the earth using the Global Positioning System (GPS). Pluralities of Floating Mirrors can be utilized to extend the sun exposure time over a given target area. By heating a column of air using the present invention water evaporates causing a cyclone to form. The cyclone in combination with the evaporated water causes rain to fall in the area of the cyclone thus creating localized weather patterns. The cyclone forming mechanism produces fresh water from seawater and in effect can transport water to desired locations depending on meteorological conditions.

### FIELD OF THE INVENTION

The present invention relates to utilization of the Earth atmosphere, Earth gravity, Earth rotation and Sun energy. More specifically, this invention relates to a method and apparatus to make a cyclone, controlling when, where, how big and its duration.

### BACKGROUND OF THE INVENTION

The weather has long been a key productive and destructive element in the history of mankind. When the weather is favorable for agriculture, crops abound and food is readily available to feed a population and to export to other countries. When the weather is unfavorable, crops wither and die, farms go out of business, prices rise, and scarcity in extreme situations leads to widespread starvation, civil unrest and even war.

In the present day, forces such as el nino and la nina combine to cause too much precipitation in some regions while others regions become parched and unfit for agriculture. While these phenomena are global in nature, other local climate changes brought about by man and manmade activities can also be detrimental in terms of overuse of water and depletion of water supplies through poor management. All of this can be exacerbated by a weather trend or climatological change that does not favor agriculture or activities that rely on the present of a steady supply of water. If climate can be managed in some fashion, then much of the difficulties and hardships from an overabundance or scarcity of water can be alleviated.

The technical term “cyclone” is a meteorological term used to describe any low pressure system that comprises an atmospheric circulation that rotates clockwise in the Southern Hemisphere (anti-clockwise in the Northern Hemisphere). These areas of lower pressure and generally associated with stronger winds, changing weather conditions, cloudiness, and rainfall.

A contributor to climate forces is the phenomenon known as the Coriolis Velocity. Coriolis Velocity is the result of a force in mechanics that deflects the motion of a body as it moves in a rotating system, influencing prevailing winds and ocean currents and named after French physicist Gaspard de Coriolis. This Coriolis velocity relative to space will be deflected in relation to the rotation of Earth. This deflection is clockwise in the northern hemisphere and counterclockwise in the southern hemisphere.

Evaporation occurs when energy from the sun causes water molecules to rises from the earth's surface. When such water vapor condenses, clouds are formed and rain occurs. When this occurs, water, if derived from the ocean, is desalinized with resulting rain being useful for agricultural purposes. When a storm occurs, the water is then potentially deposited on land where it nourishes crops and enters the ground water system.

However, groundwater is also under increasing pressure from amn's expansion. This is now to the point were, given rainfall shortages and increase use pressures, the groundwater system is seriously endangered.

It would therefore be truly useful to harness the weather to alleviate groundwater scarcity and to increase rainfall where and when needed. Thus it is desirable to have a method to make and control weather through creation of a localized weather pattern, which will allow mankind to select the time, location, magnitude, duration and the purpose of the weather produced.

### SUMMARY OF THE INVENTION

The present invention is a system and method for production of a cyclone by using a network of suspended mirrors at high altitudes to reflect the sun's energy in a local area, thereby evaporating moisture into the atmosphere and creating a localized weather pattern that produces rain.

It is an object of the present invention to create a localized weather pattern that produces rain.

It is an object of the present invention to make water through weather-induced desalination.

It is an object of the present invention to purify water.

It is an object of the present invention to use manmade weather systems to transport water.

It is an object of the present invention to use manmade weather systems for water irrigation.

It is an object of the present invention to use the manmade weather systems for ozone layer regeneration.

It is an object of the present invention to use the manmade weather systems to decease global warming.

It is an object of the present invention to use manmade weather patterns for local area cooling.

It is an object of the present invention to use manmade weather patterns for local area shading.

It is an object of the present invention to use manmade weather patterns for power generation by waterfall.

It is an object of the present invention to use manmade weather patterns for power generation by increasing winds speed in an area and converting the wind energy into electrical energy.

It is an object of the present invention to use a “floating mirror” positioned above the surface of the earth for power generation by increasing the sun exposure to a photoelectric panel.

It is an object of the present invention to use the floating mirror for power generation by increasing the exposure and concentration of sun energy to a thermoelectric plant.

It is an object of the present invention to use the floating mirror for local area heating.

It is an object of the present invention to use the floating mirror for local area illumining.

It is an object of the present invention to use the floating mirror for reflecting sun light to other floating mirror thereby better directing the sun's energy to desired locations.

It is an object of the present invention to use the floating mirror for local area shadowing by the production of localized weather patters.

It is an object of the present invention to use the floating mirror for reflecting sun light to a fixed or mobile mirror on earth whereby the sun's energy can be further reflected to other desired locations.

It is an object of the present invention to use the floating mirror for reflecting sun light to a fixed or mobile terrestrial mirror for military use.

It is an object of the present invention to use manmade weather patterns for military purposes.

It is an object of the present invention to use manmade weather patterns for control a natural Hurricane by producing a highly localized weather pattern to prevent the sun's energy from entering the “eye” of a hurricane thereby depriving the hurricane of more energy from the sun.

According to the present invention, a method and apparatus is provided for making a localized weather pattern. In a large shadow zone the delivery of vertical or near-vertical energy from the sun to a water body creates evaporation of the water. The air and water vapor then rises and the air around the target area takes its place. Due to Coriolis velocity the new air circulates in an anti-clockwise direction to form local weather patter known as a cyclone (in the northern hemisphere).

In the present invention the energy from the sun is delivered vertically to the surface of the earth at a particular location (a “target area”) using a “floating mirror” suspended above the surface of the earth either via a helium balloon or earth-orbiting mirror satellite. The heat created in the vertical column heats the air column and the water on the surface of the earth causing the water to evaporate and rise with the column of air above the target area creating a vacuum at the earth's surface. The surrounding high-pressure air fills the lower density column at Coriolis velocity. The evaporated water rises up to reach an equilibrium at approximates 10,000 meters and forms moving clouds at Coriolis velocity, reducing or blocking the sun's rays in areas distant from the target area. The circular motion induced by the rising column of air makes the clouds cross the earth magnetic field repeatedly causing lightning and rain.

As a consequence of this action, the present invention also causes oxygen to rise through the heated column of less dense air and thus be exposed to increasing amounts of ultra violet energy at the higher altitudes of the heated column. This in turn causes the oxygen to be converted to ozone that can be used to replenish the depleted ozone layer.

The system of the present invention utilizes one or more floating mirror that are geo-stationery and positioned using, for example, the Global Positioning System (GPS). A propulsion system on the floating mirrors maintains the relative position of the floating mirror over a target area thereby extending the sun's exposure of the target area for a predictable and controlled amount of time. When the desired effect on the local weather is achieved, the delivery of the sun's energy to the target area can be halted.

A further enhancement to the positioning of the floating mirror involves placing a vertical laser on the surface of the earth at or near the target area. This laser can then be sensed by position sensors on the floating mirror to increase the accuracy of delivery of the sun's energy to the target area with even more accuracy that can be achieved via a GPS system.

When used in a spaced based mode, the floating mirror senses the earth location of the vertical laser. In either the balloon deployed mode or the space based mode, once the Floating Mirror is at the appropriate position as determined by the GPS, the floating mirror locks that position by finding the Vertical Laser signal. Continuous sensing of the ground based laser causes the floating mirror propulsion system to continuously adjust the position of the floating mirror so that is located vertically over the target area thereby constantly delivery the sun's energy to the heated column of air over the target area. Thus the floating mirror computer adjusts the mirror at all times to delivery the sun energy to the target.

On on-board computer system of the floating mirror also adjusts and associated floating mirror solar array to most efficiently collect the sun's energy for powering the floating mirror and all of its station-keeping functions. The energy collected also charges batteries that may be used for various functions of the floating mirror.

Station-keeping software that notes position relative to the surface of the earth, orientation of the floating mirror to the ground, and other functions continuously adjusts the floating mirror at all times to enable delivery of the sun's energy vertically to the target area.

### BRIEF DESCRIPTION OF THE SEVERAL VIEWS OF THE DRAWINGS

FIG. 1 illustrates a floating mirror apparatus of the present invention.

FIG. 2 illustrates the floating mirror apparatus and its internal mechanical components.

FIG. 3 illustrates the floating mirror apparatus and its generalized internal electrical and electronic components.

FIG. 4 illustrates the present invention in operation over the surface of the earth.

FIG. 5 illustrates the present invention wherein multiple floating mirrors reflect energy to other floating mirrors.

### DETAILED DESCRIPTION OF THE INVENTION

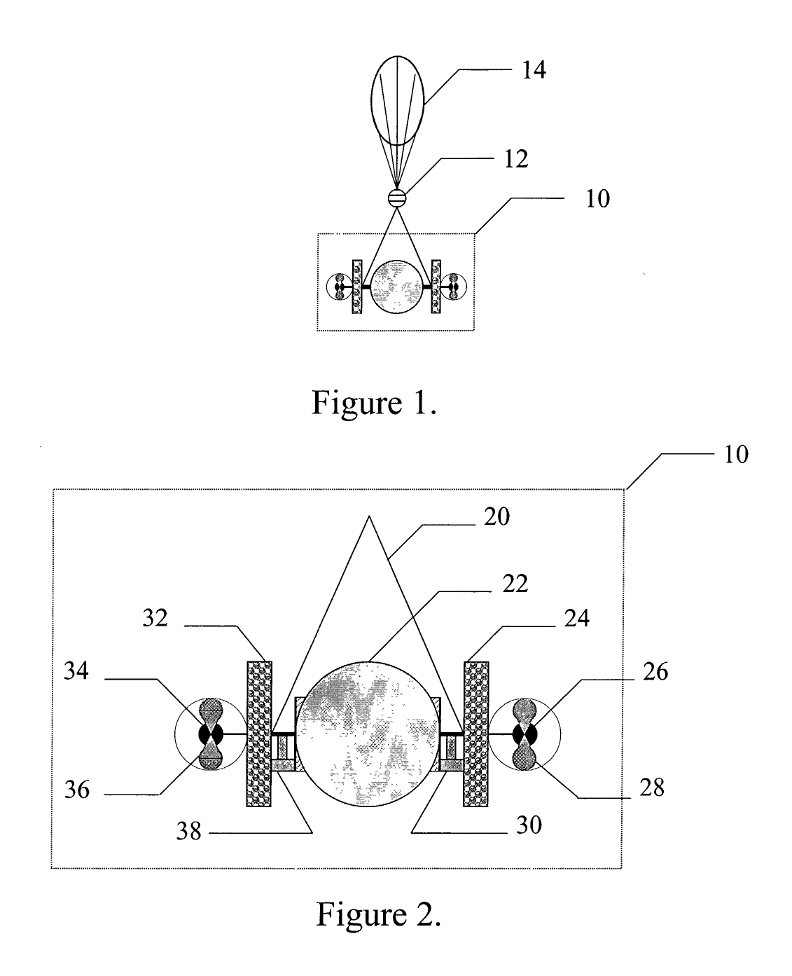

Referring to FIG. 1 the floating mirror of the present invention is illustrated. A mirror subsystem 10, is suspended a balloon 14, using a free rotation coupler 12.

In addition the floating mirror comprises a balloon pressure monitor for monitoring the pressure of the balloon at all times to prevent explosion and keep the excess of helium on a pressured cylinder in accordance with this invention. Balloon 14 is a helium filled balloon of the type know in the art. The device is designed to float at various levels in the atmosphere up to the limit of such balloon technology. For example, it is anticipated that balloon technology will improve in the future and the present invention will be equally useful for any such balloon that may exist in the future.

Referring to FIG. 2, the mirror sub-system (FIG. 1, 10) is further illustrated. A cable 20 supports the mirror subsystem 22 from the balloon (FIG. 1, 14). A support structure supports the mirror 22, solar panels 24 and 32, propulsion system 26 and 34 with its respective blades 28 and 36. Motors 30 and 38 serve to move the mirror 22 to keep it aligned with the target area. Motors 30 and 38 also keep solar panels 24 and 32 optimally aligned with the sun to generate and collect electrical power to support the functions of the floating mirror.

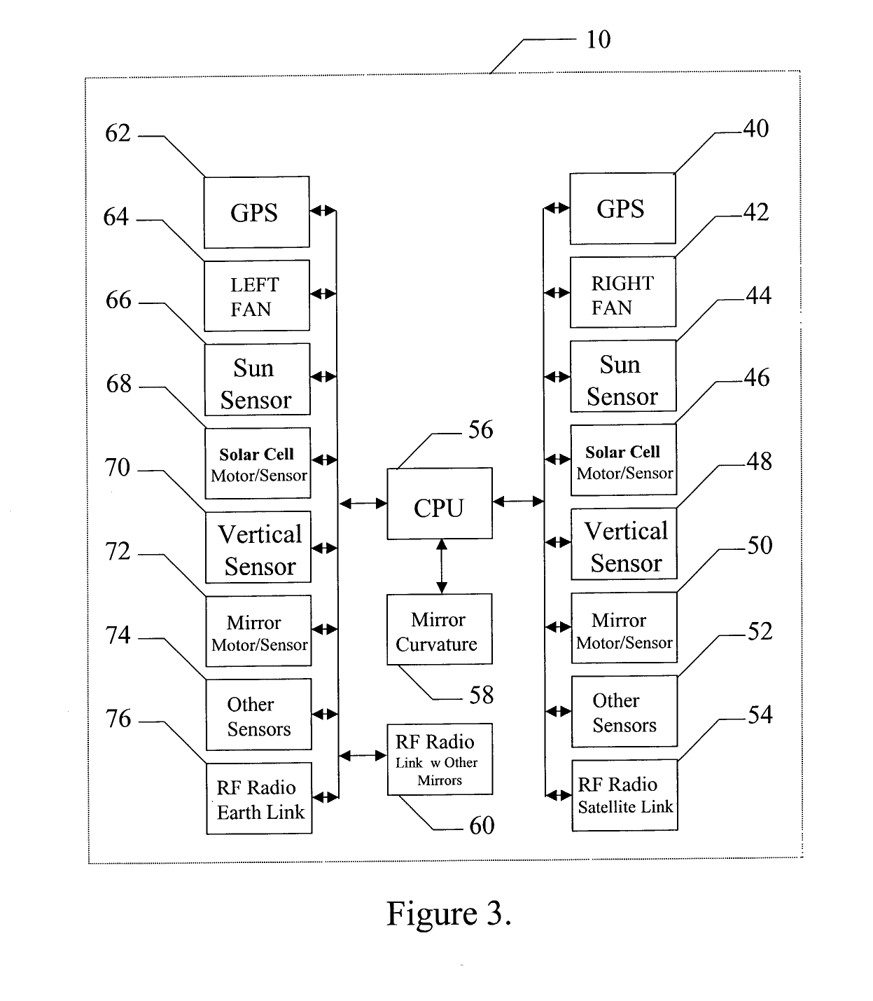

Referring to FIG. 3, the internal electronic parts and components of the floating mirror are illustrated. The Central Processing Unit 56 controls all functions of the floating mirror. GPS 40 and 62 provide the location input of the floating mirror to the central processing unit 56 which in turn sends signals to the propulsion system to maintain the desired position over the target area. Radios 54, 76 and 60 the CPU 56 receive the target location and using the propulsion system interface 42 and 64 the floating mirror can proceed to its desired destination and maintain that position. Sun Sensor 44 and 68 and the interfaces 46 and 70 allow the CPU 56 to rotate the floating mirror using the propulsion system 42 and 64 and aim the solar panels toward the sun to maximize power generation. The vertical sensors 48 and 76 allow the CPU 56 using the interfaces 50 and 72 to move the mirror to the correct orientation to deliver a vertical sunbeam to the target location.

Other sensors 52 and 74 provide information about the temperature, altitude, win speed, batteries levels, helium pressure and storage to the CPU 56 for a variety of “housekeeping” functions.

Mirror curvature 58 is capable of being adapted to meet the requirements of the target area. For example, if a larger are is to be illuminated, the curvature of the mirror, which may be multi-segmented can be changed to provide broader area coverage. If the beam of energy is to be concentrated, the curvature of the mirror can be adjusted to accommodate this task. An interface between the CPU 56 and the mirror 58 allows the CPU 56 to send instructions to the mirror to mechanically modify the mirror curvature to enlarge or reduce the illumination of the target area.

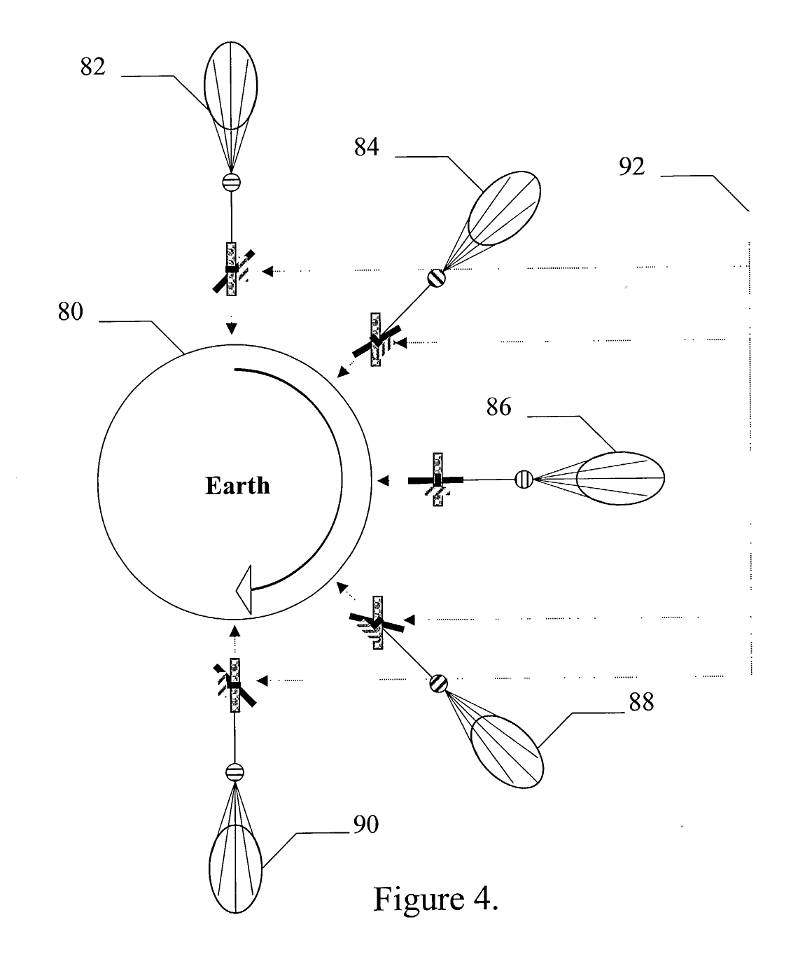

Referring to FIG. 4, the operation of the present invention over the surface of the earth is generally illustrated. The sunrays 92 illuminate the Earth. A floating mirror is positioned over the same target area on earth at, for example, five different times, at 6 AM 82, 9 AM 84, 12 noon 86, 3 PM 88 and 6 PM 90. The Floating Mirror moves with the Earth rotation. The on-board CPU (FIG. 3, 56) guarantees the target area is continually illuminated by adjusting the positions of the floating mirror, and the orientation of the mirror sub-system, (FIG. 2, 22) together with solar Panels (FIG. 2, 24 and 32) so that maximum power is generated when needed and so that the mirror sub-system contently provides a vertical column of the sun's energy over the target area.

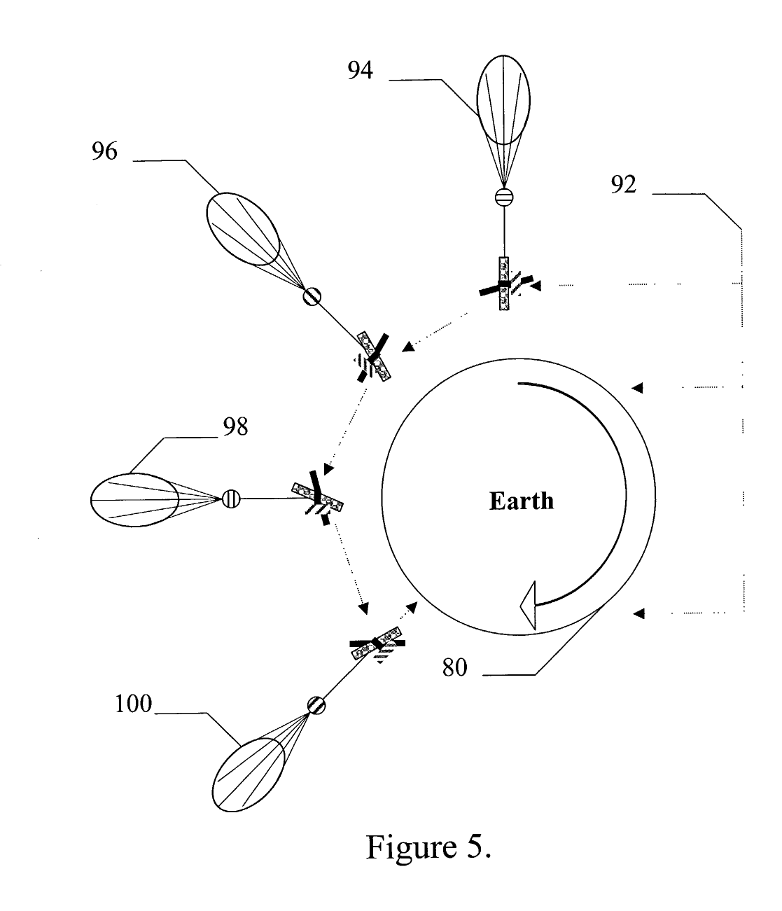

Referring to FIG. 5, a further deployment of the present invention is illustrated. In this instance the present invention is positioned to achieve 24-hour delivery of energy from the sun to a target area. The sunrays 92 generally illuminate the Earth 80. In this illustration, four Floating Mirrors 94, 96, 98 and 100 are illustrated as located on the dark portion of the Earth 80. The floating mirrors move with the Earth rotation.

In this illustration floating mirror 100 delivers the sun's energy to the target area after that energy is reflected from floating mirrors 94, 96, and 98. The intervening floating mirrors are advantageously sized and their respective curvatures are modified to most effectively deliver the sun's energy to floating mirror 100. In this illustration the number of floating mirrors illustrated is by way of example only. Fewer or a greater number of floating mirrors may be employed ad the geometry of the particular situation dictates.

Although the invention has been shown and described with respect to exemplary embodiments thereof, various other changes, omissions and additions in form and/or detail thereof will be appreciated by those skilled in without departing from the scope of the invention.

I claim:

1. A method for making a cyclone comprising;
delivering the sun's energy to a target area in a vertical or near-vertical orientation.

2. The method for making a cyclone of claim 1 wherein:
delivering the sun's energy further comprises reflecting the sun's energy by positioning a floating mirror over the target area.

3. The method for making a cyclone of claim 2 further comprising:
orienting the floating mirror to collect the sun's rays and to reflect the sun's rays onto the target area.

4. The method for making a cyclone of claim 3 further comprising:
maintaining the position of the floating mirror over the target area for a user defined period of time.

5. The method for making a cyclone of claim 4 wherein:
maintaining the position of the floating mirror over the target area further comprises defining a desired position for the floating mirror in three dimensions;
receiving signals from a global positioning system (GPS) at the floating mirror indicating the three dimensional position of the floating mirror; and
adjusting the position of the floating mirror via a propulsion system to maintain the desired position.

6. The method for making a cyclone of claim 2 wherein the floating mirror comprises adaptive optics.

7. The method for making a cyclone of claim of claim 6 wherein adaptive optics cause a modification in the curvature of the floating mirror.

8. The method for making a cyclone of claim 2 wherein position the floating mirror is over a target area comprises suspending the floating mirror from a balloon.

9. The method for making a cyclone of claim 8 wherein suspending the mirror from a balloon further comprises:
establishing an altitude for the balloon in the regions consisting of the stratosphere, the thermosphere, and the mesophere.

10. A method for desalinizing water comprising:
delivering the sun's energy to a sea water target area in a vertical or near-vertical orientation.

11. The method for desalinizing water of claim 10 wherein:
delivering the sun's energy further comprises reflecting the sun's energy by positioning a floating mirror over the target area.

12. The method for desalinizing water of claim 11 further comprising:
orienting the floating mirror to collect the sun's rays and to reflect the sun's rays onto the target area.

13. The method for desalinizing water of claim 12 further comprising:
maintaining the position of the floating mirror over the target area for a user defined period of time.

14. The method for desalinizing water of claim 13 wherein:
maintaining the position of the floating mirror over the target area further comprises defining a desired position for the floating mirror in three dimensions;
receiving signals from a global positioning system (GPS) at the floating mirror indicating the three dimensional position of the floating mirror; and
adjusting the position of the floating mirror via a propulsion system to maintain the desired position.

15. The method for desalinizing water of claim 10 wherein the floating mirror comprises adaptive optics.

16. The method for desalinizing water of claim 15 wherein the adaptive optics cause a modification in the curvature of the floating mirror.

17. A method for ozone layer replenishment comprising:
delivering the sun's energy to a target area in a vertical or near-vertical orientation.

18. The method for ozone layer replenishment of claim 17 wherein:
delivering the sun's energy further comprises reflecting the sun's energy by positioning a floating mirror over the target area.

19. The method for ozone layer replenishment of claim 18 further comprising:
orienting the floating mirror to collect the sun's rays and to reflect the sun's rays onto the target area.

20. The method for ozone layer replenishment of claim 19 further comprising:
maintaining the position of the floating mirror over the target area for a user defined period of time.

21. The method for ozone layer replenishment of claim 20 wherein:
maintaining the position of the floating mirror over the target area further comprises defining a desired position for the floating mirror in three dimensions;
receiving signals from a global positioning system (GPS) at the floating mirror indicating the three dimensional position of the floating mirror; and
adjusting the position of the floating mirror via a propulsion system to maintain the desired position.

22. The method for ozone layer replenishment of claim 18 wherein the floating mirror comprises adaptive optics.

23. The method for ozone layer replenishment of claim 22 wherein adaptive optics cause a modification in the curvature of the floating mirror.

24. The method for ozone layer replenishment of claim 18 wherein position the floating mirror over a target area further comprises suspending the floating mirror from a balloon.

25. The method for ozone layer replenishment of claim 24 wherein suspending the mirror from a balloon further comprises:
establishing an altitude for the balloon in the regions consisting of the stratosphere, the thermosphere, and the mesophere.
